(19) United States
(12) Patent Application Publication
(10) Pub. No.: US 2023/0176981 A1
(43) Pub. Date: Jun. 8, 2023

(54) DATA PROCESSING METHOD AND ACCELERATION UNIT

(71) Applicant: MONTAGE TECHNOLOGY CO., LTD., Shanghai (CN)

(72) Inventors: Kun WEI, Shanghai (CN); Shanmin GUO, Shanghai (CN); Guoxin CAO, Shanghai (CN)

(73) Assignee: MONTAGE TECHNOLOGY CO., LTD., Shanghai (CN)

(21) Appl. No.: 17/980,581

(22) Filed: Nov. 4, 2022

(30) Foreign Application Priority Data
Dec. 3, 2021 (CN) 2021114660613

(51) Int. Cl. G06F 12/126

(52) U.S. Cl. CPC G06F 12/126; G06F 2212/70

(57) ABSTRACT

A data processing method and an acceleration unit are provided. The method includes: S11, reading a row of a target matrix as a target row; S12, shifting elements in the target row along a first direction to acquire a shifted target row according to a preset offset, and writing each element in the shifted target row into a corresponding row buffer respectively; S13, reading a next row of the target row from the target matrix as a new target row, if the next row of the target row is not the last row of the target matrix and an available storage space exists in the row buffers; S14, reading corresponding elements from each row buffer according to a preset rule, and writing the elements read from each row buffer into an output buffer as a row, step S14 is repeated until all elements in all row buffers are written into the output buffer.

### CROSS REFERENCE TO RELATED APPLICATION

This application claims the benefits of priority to Chinese Patent Application No. CN 2021114660613, entitled “Data Processing Method and Acceleration Unit”, filed with CNIPA on Dec. 3, 2021, the content of which is incorporated herein by reference in its entirety.

### FIELD OF TECHNOLOGY

The present disclosure relates to the field of processing methods, and more specifically, to a data processing method and an acceleration unit.

### BACKGROUND

With the development of technology, more and more computer systems adopt a pipelined acceleration unit structure to improve the processing speed of a processor. The acceleration unit refers to a processing unit integrated in a processor and may assist the processor to handle specialized computing tasks. These specialized computing tasks may be graphics processing, vector computing, or the like.

Matrix transposition is an important operation in many computer applications. Existing solutions mainly focus on problems of matrix transposition in memories in a Graphics Processing Unit (GPU) or Central Processing unit (CPU), which requires the processor to perform matrix transposition frequently. Conventionally, matrix transposition is mainly achieved by reading from and writing to the same memory, while in a pipelined acceleration unit structure, the matrix is often read from one memory and then written to another after several stages of pipelining. This makes it difficult to apply conventional matrix transposition methods to the pipelined acceleration unit structure.

### SUMMARY

The present disclosure provides a data processing method, operable for transposing a target matrix. The data processing method includes: S11, reading a row of the target matrix as a target row; S12, shifting elements in the target row along a first direction to acquire a shifted target row according to a preset offset, and writing each element in the shifted target row into a corresponding row buffer respectively; S13, reading a next row of the target row from the target matrix as a new target row, if the next row of the target row is not the last row of the target matrix and there is an available storage space in the row buffers; steps S12-S13 are performed repeatedly; and S14, reading corresponding elements from each row buffer according to a preset rule, and writing the elements read from each row buffer into an output buffer as a row; step S14 is repeated until all elements in all row buffers are written into the output buffer.

In an embodiment, the step of shifting elements in the target row along a first direction according to a preset offset includes: dividing the target row into a plurality of subvectors, and cyclically shifting elements in each subvector along the first direction according to the preset offset, wherein the number of the subvectors is L and L is an integer greater than or equal to one.

In an embodiment, the step of cyclically shifting elements in each subvector along the first direction includes: cyclically shifting the elements in each subvector to the right.

In an embodiment, L=ceil (A/B), ceil is a ceiling function, A is the number of columns of the target matrix, B is the number of rows of the row buffers.

In an embodiment, the preset offset is set according to the row number of the target row in the target matrix.

In an embodiment, the step of writing each element in the shifted target row into a corresponding row buffer respectively includes: sequentially writing each element of each subvector in the shifted target row into a corresponding row buffer respectively.

In an embodiment, the step of reading corresponding elements from each row buffer according to a preset rule, and writing the elements read from each row buffer into an output buffer as a row includes: for the K-th reading operation, determining a reading sequence corresponding to each row buffer and storage positions of the elements to be read from each row buffer according to the preset rule, where K is an integer greater than or equal to one; and reading corresponding elements from each row buffer according to the reading sequence and the storage positions, and writing the elements read from each row buffer into the output buffer as a row.

In an embodiment, the preset rule includes: if K=1, determining the reading sequence S, corresponding to each row buffer according to the row number i of each row buffer, and determining a storage position in the i-th row buffer where an element to be read is stored according to ceil (A/B).Sᵢ, where ceil is a ceiling function, A is the number of columns of the target matrix, B is the number of rows of the row buffers; and if K>1, acquiring the reading sequence corresponding to each row buffer for the K-th reading operation by cyclically shifting the reading sequence corresponding to each row buffer for the (K−1)-th reading operation to the right by one position; for the i-th row buffer, acquiring the storage position where the element to be read is stored for the K-th reading operation by shifting ceil (A/B) positions to the left from a storage position of an element read for the (K−1)-th reading operation.

In an embodiment, if the number of columns of the target row is greater than the number of rows of the row buffers, the data processing method further includes: S15, reading a next row of the target row from the target matrix as a new target row, and writing each element in the new target row into a corresponding row buffer respectively, where step S15 is repeated until the new target row is the last row of the target matrix or there is no more available storage space in the row buffers; and S16, reading corresponding elements from each row buffer according to the preset rule, writing the elements read from each row buffer into a corresponding row of the output buffer, where step S16 is repeated until all elements in all row buffers are written into the output buffer.

The present disclosure also provides an acceleration unit, including: an input buffer, for buffering a target matrix to be transposed; a shifter, for receiving a target row of the target matrix, and for shifting elements in the target row along a first direction under the control of a shift control signal, to acquire a shifted target row; at least two row buffers, for buffering elements in the shifted target row and for outputting elements read correspondingly from each row buffer; a combiner, for writing the elements read correspondingly from each row buffer into an output buffer as a row; and a transposition controller, for generating the shift control signal according to the size of the target matrix and the number of rows of the row buffers, for controlling the input buffer to read the first row of the target matrix and outputting the first row as the target row to the shifter, for controlling the shifter to shift the target row to acquire the shifted target row, for controlling the shifter to write each element in the shifted target row into a corresponding row buffer, and for outputting the elements read correspondingly from each row buffer to the combiner.

In an embodiment, the acceleration unit further includes: an accumulator, for buffering subvectors to be shifted in the target row under the control of an accumulation control signal, and for outputting one subvector to the shifter at a time in sequence, to enable the shifter to shift the subvectors; where the target row is divided into several subvectors, where the number of the subvectors is L and L is an integer greater than or equal to one; the transposition controller also generates the accumulation control signal and outputs the accumulation control signal to the accumulator if the number of columns of the target matrix is greater than the number of rows of the target matrix.

In an embodiment, L=ceil (A/B), where ceil is a ceiling function, A is the number of columns of the target matrix, B is the number of rows of the row buffers.

In an embodiment, the shifter cyclically shifts the elements of each subvector in the target row to the right according to a preset offset.

In an embodiment, the preset offset is set according to the row number of the target row in the target matrix.

In an embodiment, the at least two row buffers determine a reading sequence corresponding to each row buffer and storage positions in each row buffer where corresponding elements to be read are stored for the k-th reading operation according to the preset rule, and read corresponding elements from each row buffer according to the reading sequence and the storage positions, and output the elements read from each row buffer to the combiner, where K is an integer greater than or equal to one.

In an embodiment, the preset rule includes: if K=1, determining the reading sequence S, corresponding to each row buffer according to the row number i of each row buffer, and determining a storage position in the i-th row buffer where an element to be read is stored according to ceil (A/B).Sᵢ, where ceil is a ceiling function, A is the number of columns of the target matrix, B is the number of rows of the row buffer; and if K>1, acquiring the reading sequence corresponding to each row buffer for the K-th reading operation by cyclically shifting the reading sequence corresponding to each row buffer for the (K−1)-th reading operation to the right by one position; for the i-th row buffer, acquiring the storage position where the element to be read is stored the K-th reading operation by shifting ceil (A/B) positions to the left from a storage position of an element read for the (K−1)-th reading operation.

In an embodiment, the input buffer is a ping pong buffer.

In an embodiment, the acceleration unit further includes: a multiplexer, coupled between an output terminal of the ping pong buffer and the accumulator, for connecting the ping pong buffer to the input buffer of the accumulator under the control of a buffer selection signal; the transposition controller also generates the buffer selection signal and outputs the buffer selection signal to the multiplexer.

In an embodiment, the acceleration unit further includes: an input controller, for inputting the target matrix to the input buffer, and for outputting the size of the target matrix to the transposition controller; and an output controller, for informing the transposition controller when a transpose completion signal from the output buffer is received, to enable the transpose controller to send the buffer selection signal to the multiplexer, thereby switching the ping pong buffer.

The present disclosure further provides a data processing method, for transposing an original matrix, including: dividing the original matrix into a plurality of submatrices, the submatrices includes diagonal submatrices and non-diagonal submatrices; transposing each diagonal submatrix in the original matrix to acquire transposed diagonal submatrices, and writing the transposed diagonal submatrices into first positions of a target buffer, the first positions correspond to original positions of the diagonal submatrices; transposing each non-diagonal submatrix in the original matrix to acquire transposed non-diagonal submatrices, and writing the transposed non-diagonal submatrices into second positions of the target buffer, the second positions are symmetrical to the original positions of the non-diagonal submatrices relative to a main diagonal of the original matrix; two non-diagonal submatrices symmetrical to the main diagonal are transposed in parallel; the step of transposing each submatrix in the original matrix including: S11, reading a row of the target matrix as a target row; S12, shifting elements in the target row along a first direction to acquire a shifted target row according to a preset offset, and writing each element in the shifted target row into a corresponding row buffer respectively; S13, reading a next row of the target row from the target matrix as a new target row, if the next row of the target row is not the last row of the target matrix and there is an available storage space in the row buffers; steps S12-S13 are performed repeatedly; and S14, reading corresponding elements from each row buffer according to a preset rule, and writing the elements read from each row buffer into an output buffer as a row, step S14 is repeated until all elements in all row buffers are written into the output buffer.

### BRIEF DESCRIPTION OF THE DRAWINGS

FIG. 1 is a block diagram of a pipelined acceleration unit structure according to an embodiment of the present disclosure.

FIG. 2A is a flowchart of a data processing method according to an embodiment of the present disclosure.

FIG. 2B is a schematic diagram of a target matrix according to an embodiment of the present disclosure.

FIG. 2C is a schematic diagram illustrating cyclically shifting elements in the row buffer 1 in FIG. 2B to the right according to an embodiment of the present disclosure.

FIG. 2D is a schematic diagram illustrating writing data into row buffers according to an embodiment of the present disclosure.

FIG. 2E is a schematic diagram illustrating cyclically shifting elements in the row buffer 2 in FIG. 2B to the right according to an embodiment of the present disclosure.

FIG. 2F is a schematic diagram illustrating writing data into row buffers according to an embodiment of the present disclosure.

FIG. 3A and 3B are schematic diagrams illustrating reading data from each row buffer according to an embodiment of the present disclosure.

FIG. 4 is a flowchart of steps after S14 of the data processing method in FIG. 2A according to an embodiment of the present disclosure.

FIG. 5A is a schematic structural diagram of acceleration units according to an embodiment of the present disclosure.

FIG. 5B is a schematic structural diagram of acceleration units according to an embodiment of the present disclosure.

FIG. 6 is a schematic flowchart of a data processing method according to an embodiment of the present disclosure.

FIG. 7 is a schematic flowchart of a data processing method according to an embodiment of the present disclosure.

### DETAILED DESCRIPTION

The following describes embodiments of the present disclosure by using specific embodiments. A person skilled in the art may easily understand other advantages and effects of the present disclosure from the content disclosed in this specification. The present disclosure may also be implemented or applied through different specific embodiments. Various details in this specification may also be modified or changed based on different viewpoints and applications without departing from the spirit of the present disclosure. It should be noted that the embodiments below and features in the embodiments can be combined with each other in the case of no conflict.

It should be noted that, the drawings provided in the following embodiments only exemplify the basic idea of the present disclosure. Therefore, only the components related to the present disclosure are shown in the drawings, and are not drawn according to the quantity, shape, and size of the components during actual implementation. During actual implementation, the type, quantity, and proportion of the components may be changed, and the layout of the components may be more complex. In addition, terms such as “first”, “second” and the like are only used to distinguish one entity or operation from another entity or operation, and do not necessarily require or imply any such actual relationship or order between these entities or operations.

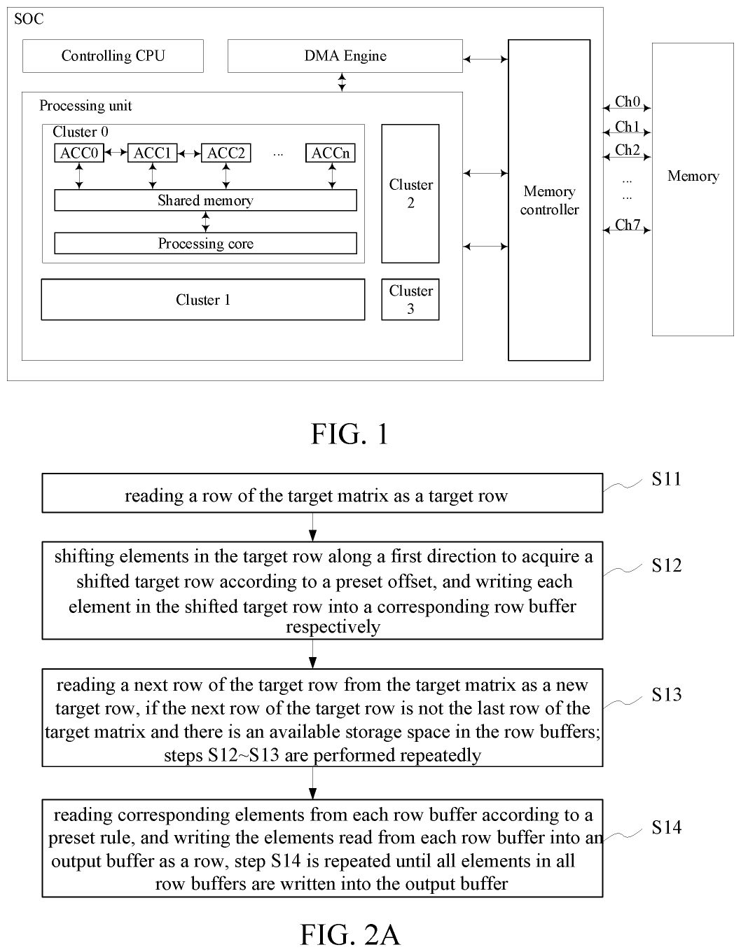

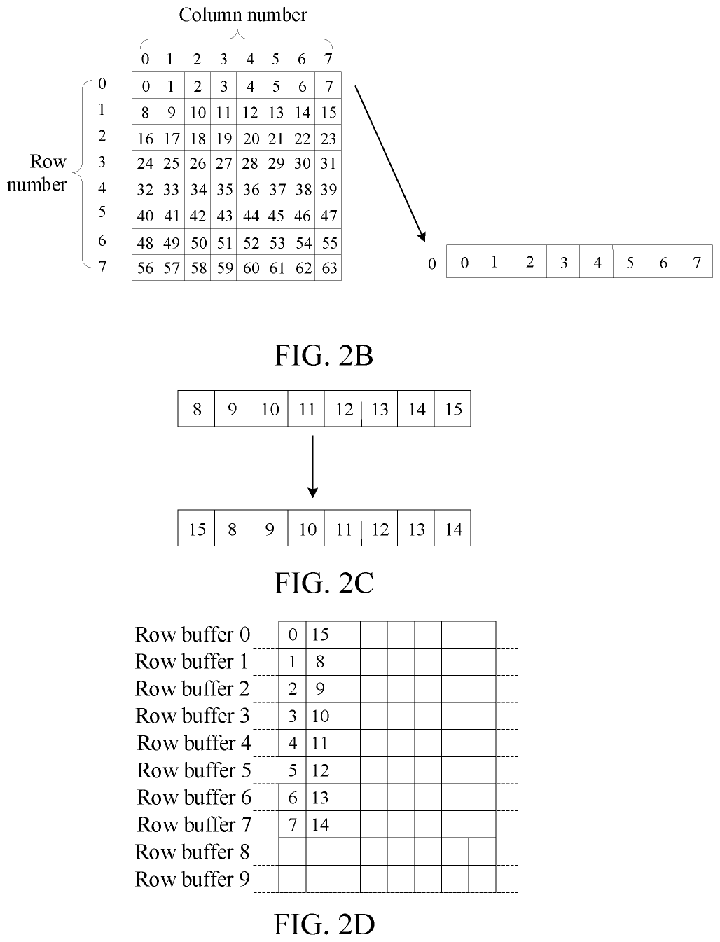

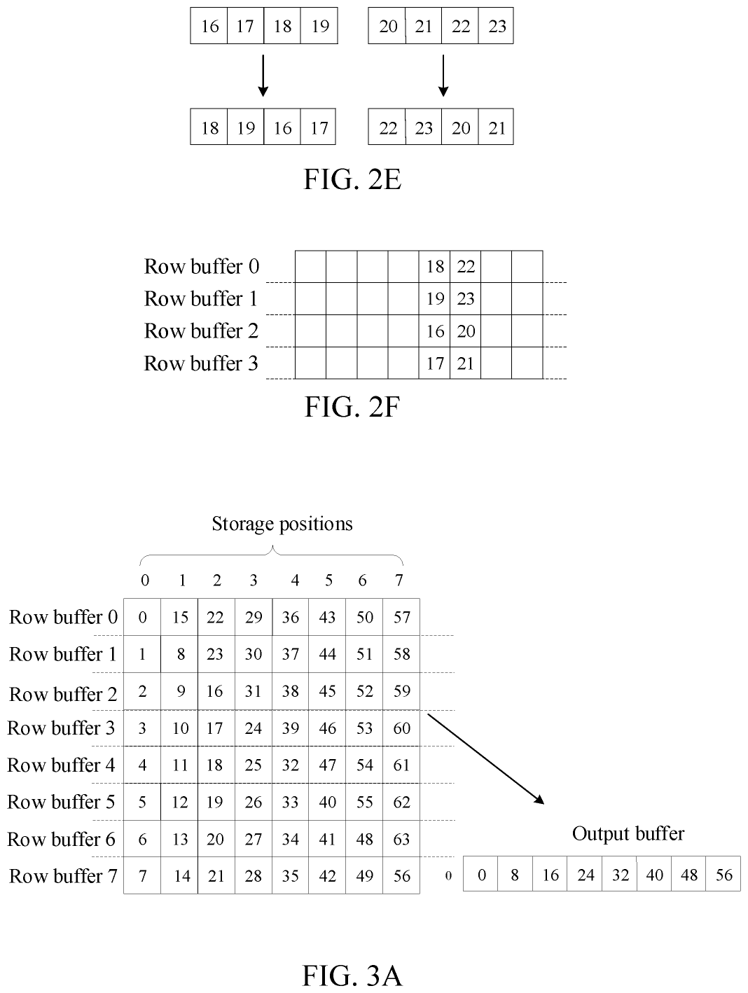

A data processing method for transposing a target matrix is provided. In some embodiments, the data processing method can be applied to each acceleration unit of a pipelined acceleration unit structure. In an embodiment, as shown in FIG. 1, the pipelined acceleration unit structure includes acceleration units ACC0, ACC1, . . . , ACCn. In an embodiment, referring to FIG. 2, the data processing method for transposing a target matrix includes:

S11, reading a row of the target matrix as a target row. For example, the target matrix may be stored in an input buffer of acceleration units. In an embodiment, the target matrix shown in FIG. 2B, the row 0 of the target matrix is read as the target row when the target matrix is read for the first time.

S12, shifting elements in the target row along a first direction to acquire a shifted target row according to a preset offset, and writing each element in the shifted target row into a corresponding row buffer respectively. The number of row buffers is at least two. In an embodiment, each element in the target row corresponds to a row buffer respectively. For different elements in the target row, corresponding row buffers may be the same or different. In an embodiment, elements in the target row may be cyclically shifted, the first direction may be to the left. That is, elements in the target row are cyclically shifted to the left. Similarly, the first direction may be to the right, that is, elements in the target row are cyclically shifted to the right.

S13, reading a next row of the target row from the target matrix as a new target row, if the next row of the target row is not the last row of the target matrix and there is an available storage space in the row buffers; steps S12-S13 are performed repeatedly. The available storage space herein refers one or more row buffers that have yet no data written into it.

S14, reading corresponding elements from each row buffer according to a preset rule, and writing the elements read from each row buffer into an output buffer as a row; step S14 is repeated until all elements in all row buffers are written into the output buffer.

As described above, the data processing method is provided in the embodiment. The data processing method transposes the target matrix by reading or writing the input buffer, row buffers, and the output buffer. Therefore, the above reading and writing processes do not require reading from or writing into the same address of the memory. In addition, the data processing method is realized by acceleration units, and thus is applicable to computer systems based on a pipelined acceleration unit structure.

In an embodiment, the offset of the target row may be set according to the row number of the target row. When the row number of the target row starts from zero, the offset of the target row may be the same as the row number of the target row. For example, if the row number of the target row is a, the offset of the target row is also a.

In embodiments of the present disclosure, each offset is the same as the row number of the corresponding target row, the first direction is to the right, elements in the target row is shifted cyclically, and the row number of the target row starts from zero.

In an embodiment, the step of shifting elements in the target row along a first direction according to a preset offset includes: dividing the target row into a plurality of subvectors, and cyclically shifting elements in each subvector along the first direction according to the preset offset, wherein the number of subvectors is L and L is an integer greater than or equal to one. In an embodiment, the number of the subvectors is given by L=ceil (A/B), wherein ceil is a ceiling function, A is the number of columns of the target matrix, B is the number of rows of the row buffers (that is, in some embodiments, B is the number of row buffers when each row buffer consists of only one row).

When the number of columns of the target matrix is not greater than the number of rows of the row buffers, then L=1, in which case all elements in the target row serve as a subvector. When the number of columns of the target matrix is greater than the number of rows of row buffers, then L>1, in which case elements in the target row are divided into multiple subvectors.

In an embodiment, as shown in FIGS. 2B, 2C, and 2D, the number of columns of the target matrix in FIG. 2B is less than the number of rows of the row buffers in FIG. 2D. In the embodiment, we take row 1 of the target matrix in FIG. 2B as an example. When the row 1 of the target matrix in FIG. 2B is the target row, the offset of the row 1 is 1, and then all elements in the row 1 serve as a subvector. After all elements in the row 1 are cyclically shifted to the right by one position (i.e., the offset is 1), we acquire a shifted row 1 shown in FIG. 2C. In another embodiment, as shown in FIGS. 2B, 2E, and 2F, the number of columns of the target matrix in FIG. 2B is greater than the number of rows of the row buffers in FIG. 2F. In the embodiment, we take row 2 of the target matrix in FIG. 2B as an example. When the row 2 of the target matrix in FIG. 2B is the target row, elements in the row 2 are divided into two subvectors, and the offset of the row 2 is 2. After the two subvectors are cyclically shifted to the right by two positions (i.e., the offset is 2), we acquire two shifted subvectors shown in FIG. 2E.

As described above, when the number of columns of the target matrix is not greater than the number of rows of row buffers, for any element Cᵢⱼ in the target row, the row number of the corresponding row buffer is given by M={i+j, i+j<N/i+1−N, i+j≥N (Suppose the row numbers of the row buffers start from zero), the storage position of the corresponding row buffer is i (Suppose the storage positions of the row buffers start from zero). N represents the number of rows of the target matrix, i represents the row number of the element, j represents the column number of the element. For example, for an element C₁₃=11, which is located in row 1 and column 3 of the target matrix as shown in FIG. 2B, the number of columns of the target matrix is 8, i+j=1+3=4, which is smaller than 8, and therefore the row number M of the row buffer corresponding to the element C₁₃ is 4, and the element C₁₃ is stored in the storage position 1 of the row buffer 4 since i=1 in this case.

The above content provides methods for acquiring the offset according to the row number of the target row and cyclically shifting elements in the target row to the right according to the offset. It should be understood that above methods are only exemplary.

In an embodiment, the step of writing each element in the shifted target row into a corresponding row buffer respectively includes: sequentially writing each element of each subvector in the shifted target row into a corresponding row buffer respectively.

As mentioned above, when the number of columns of the target matrix is not greater than the number of rows of row buffers, all elements in the target row are one subvector, and each element in the shifted target row is written into corresponding row buffers respectively in sequence. For example, for the target row shown in FIG. 2C, the eight shifted elements 15, 8, 9, . . . , 14 are written into the row buffer 0, the row buffer 1, . . . , and the row buffer 7 respectively, as shown in FIG. 2D.

If the number of columns of the target matrix is greater than the number of rows of the row buffers and the number of subvectors is greater than 1, in which case the number of shifted subvectors is greater than 1, and the writing operation can be performed from the first shifted subvector. That is, each element in the first shifted subvector is written into a corresponding row buffer respectively, and then each element in the second shifted subvector is written into a corresponding row buffer respectively, and so on and so forth until elements in all shifted subvectors are written into their corresponding row buffers. For example, in the target row shown in FIG. 2E, elements 18, 19, 16, 17 in the first shifted subvector are respectively written into their corresponding row buffers shown in FIG. 2F, and then elements 22, 23, 20, 21 in the second shifted subvector are respectively written into their corresponding row buffers shown in FIG. 2F.

In an embodiment, the step of reading corresponding elements from each row buffer according to a preset rule, and writing elements read from each row buffer into an output buffer as a row includes: for the K-th reading operation, determining a reading sequence corresponding to each row buffer and storage positions of the elements to be read from each row buffer according to the preset rule, K is an integer greater than or equal to 1; and reading corresponding elements from each row buffer according to the reading sequence and the storage positions, and writing the elements read from each row buffer into the output buffer as a row.

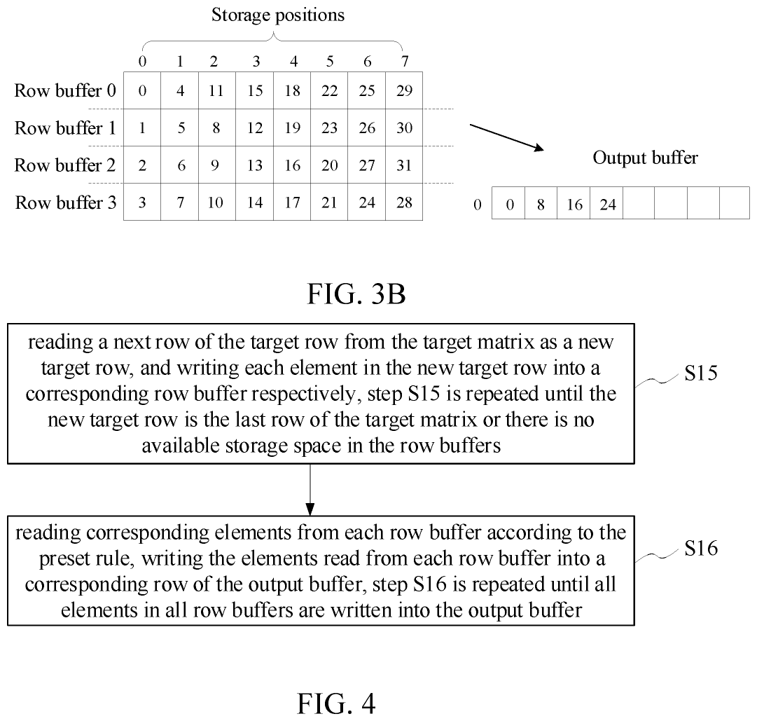

In an embodiment, the preset rule is as follows: if K=1 (i.e., elements in each row buffer are read for the first time), determining the reading sequence S, corresponding to each row buffer according to the row number i of each row buffer, and determining a storage position in the i-th row buffer where an element to be read is stored according to ceil (A/B).Sᵢ. For example, if the row numbers of the row buffers start from zero, the reading sequence S, corresponding to each row buffer is the same as the row number of each row buffer when K=1. For example, for row buffers shown in FIG. 3A, when elements in each row buffer are read for the first time, the reading sequences S, of the row buffer 0, the row buffer 1, . . . , the row buffer 7 are 0, 1, . . . , 7 respectively. That is, elements in the row buffer 0 is read first, elements in the row buffer 1 is read second, . . . , elements in the row buffer 7 is read finally. Taking the row buffer 1 as an example, ceil (A/B)=1, and then the reading sequence S, of the row buffer 1 is 1. Therefore, an element (e.g., the element 8) is read from the storage position 1 of the row buffer 1 for the first time according to ceil (A/B).Sᵢ. Similarly, we may also acquire elements read from other row buffers. For example, elements read from the row buffer 0, the row buffer 1, . . . , the row buffer 7 respectively correspond to 0, 8, 16, 24, 32, 40, 48, 56, and these elements are written into row 0 of the output buffer. For example, for row buffers shown in FIG. 3B, the reading sequences S, of the row buffer 0, the row buffer 1, the row buffer 2, the row buffer 3 respectively correspond to 0, 1, 2, 3. Taking the row buffer 1 as an example, ceil (A/B)=2, and then the reading sequence S, of the row buffer 1 is 1. Therefore, it is the element (e.g., the element 8) in the storage position 2 of the row buffer 1 that is read for the first time according to ceil (A/B).Sᵢ. Similarly, elements read from the row buffer 0, the row buffer 1, the row buffer 2, the row buffer 3 respectively correspond to 0, 8, 16, 24, and these elements are written into row 0 of the output buffer.

If K>1, the reading sequence corresponding to each row buffer for the K-th reading operation is acquired by cyclically shifting the reading sequence corresponding to each row buffer for the (K−1)-th reading operation to the right by one position, and for the i-th row buffer, the storage position where the element to be read is stored for the K-th reading operation is acquired by shifting ceil (A/B) positions to the left from a storage position of an element read for the (K−1)-th reading operation. In an embodiment, as shown in FIG. 3A, when elements in row buffers are read for the first time, the corresponding reading sequences of the row buffer 0, the row buffer 1, . . . , and the row buffer 7 are 0, 1, . . . , and 7 respectively. And then the above reading sequences are cyclically shifted to the right by one position to acquire a new reading sequence (that is, 7, 0, . . . , and 6). The new reading sequence is the sequence in which elements in each row buffer are read for the second time. At this time, elements in the row buffer 1 is read first, elements in the row buffer 2 is read second, . . . , elements in the row buffer 0 is read lastly. Taking the row buffer 0 as an example, the element read from the row buffer 0 for the first time is the element 0 stored in the storage position 0. We may acquire the storage position 7 when the storage position 0 is shifted to the left by ceil (A/B) positions, that is, the element read from the row buffer 0 for the second time is the element 57 stored in the storage position 7. Combined with the above reading sequence, elements read from the row buffer 1, the row buffer 2, . . . , the row buffer 7, and the row buffer 0 are 1, 9, 17, 25, 33, 41, 49, and 57 respectively. These elements are written into a row 1 of the output buffer.

As described above, when the number of columns of the target matrix is not greater than the number of rows of the row buffers, for the k-th row to be written in the output buffer, the row number (suppose that the row number of row buffers starts from zero) of the row buffers corresponding to the storage position n is given by n={n+k, n+k≤N/n+K−N, n+k≥N, and the storage position (suppose that the storage positions of row buffers start from zero) of the corresponding row buffer is k.

In an embodiment, as shown in FIG. 4, if the number of columns of the target matrix is greater than the number of rows of row buffers, after the step S14 is performed, the data processing method further includes:

S15, reading a next row of the target row from the target matrix as a new target row, and writing each element in the new target row into a corresponding row buffer respectively; step S15 is repeated until the new target row is the last row of the target matrix or there is no available storage space in the row buffers. In an embodiment, contents stored in row buffers are cleared before the step S15 is performed, then each element in the new target row is written into the corresponding row buffer respectively. In another embodiment, each element in the new target row is written into the corresponding row buffer respectively by overwriting during step S15 is performed.

S16, reading corresponding elements from each row buffer according to the preset rule, writing the elements read from each row buffer into a corresponding row of the output buffer; step S16 is repeated until all elements in all row buffers are written into the output buffer. For example, a row of the output buffer to be written in may be determined by the writing sequence of the row of the output buffer. In an embodiment, both the writing sequence and the row numbers of the output buffer start from zero, and the row number of a certain row of the output buffer can be determined by the writing sequence of the row of the output buffer. For example, when the writing sequence of a row is 0 (a row is written into the output buffer for the first time), the row is written into row 0 of the output buffer in step S16, so the row 0 of the output buffer is formed by combining elements written into row 0 of the output buffer in step S14 with elements written into row 0 of the output buffer in step S16. As shown in FIG. 3B, elements written into row 0 of the output buffer in step S14 are 0, 8, 16, 24, and elements written into row 0 of the output buffer in step S16 are 32, 40, 48, 56. These elements are combined to form row 0 of the output buffer.

According to the above description, when the number of columns of the target matrix is greater than the number of rows of the row buffers, a method for repeatedly reading and writing row buffers is provided in the embodiment. The remaining elements or part of remaining elements in the target matrix may also be written into the output buffer by using above method. It should be understood that, when step S15 and step S16 also fail to write all elements in the target matrix to the output buffer, step S15 and step S16 may be performed repeatedly until all elements in the target matrix are written into the output buffer.

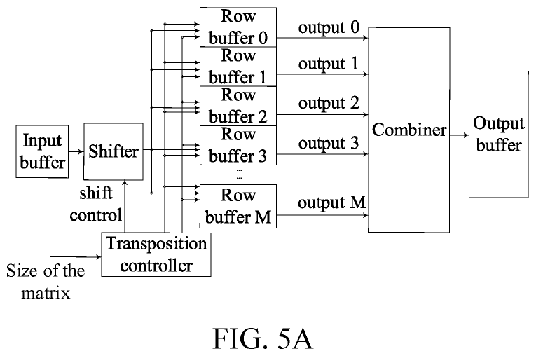

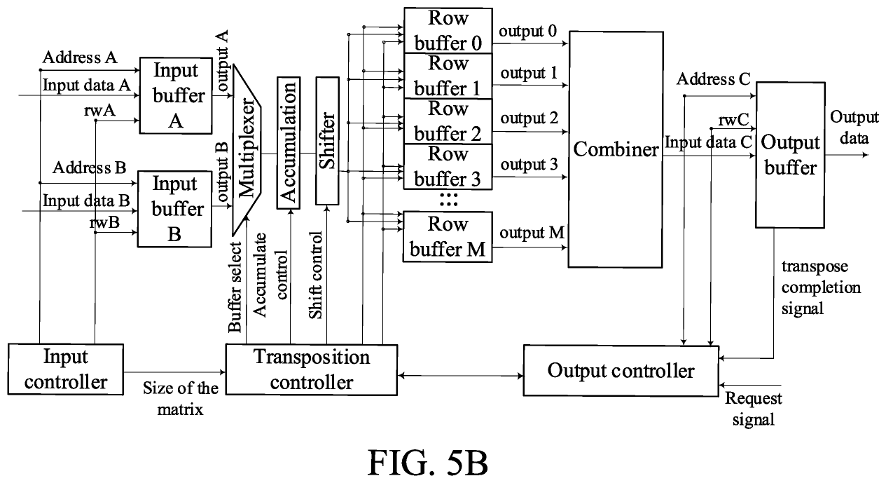

In an embodiment, any of the above data processing methods may be applied to an acceleration unit. As shown in FIG. 5A, the acceleration unit includes: an input buffer, a shifter, at least two row buffers, a combiner, an output buffer, and a transposition controller. The input buffer is for buffering a target matrix to be transposed. The shifter is for receiving a target row of the target matrix, and for shifting elements in the target row along a first direction under the control of a shift control signal, to acquire a shifted target row. In an embodiment, elements in the target row may be cyclically shifted, and the first direction may be to the right. In an embodiment, under the control of the shift control signal, the shifter shifts elements in the target row according to the preset offset. The offset is set according to the row number of the target row in the target matrix. In an embodiment, when the row numbers of the target matrix start from zero, we set the offset of the target row may be the same as the row number of the target row. At least two row buffers are for buffering elements in the shifted target row and for outputting elements read correspondingly from each row buffer. The combiner is for writing the elements read correspondingly from each row buffer into the output buffer as a row. The transposition controller is for generating the shift control signal according to the size of the target matrix and the number of rows of the row buffers, for controlling the input buffer to read a row of the target matrix and outputting the row as the target row to the shifter, for controlling the shifter to shift the target row to acquire the shifted target row, and for controlling the shifter to write each element in the shifted target row into a corresponding row buffer, and for outputting the elements read correspondingly from each row buffer to the combiner.

In an embodiment, at least two row buffers determine a reading sequence corresponding to each row buffer and storage positions in each row buffer where corresponding elements to be read are stored for the k-th reading operation according to the preset rule, and read corresponding elements from each row buffer according to the reading sequence and the storage positions, and output the elements read from each row buffer to the combiner, K is an integer greater than or equal to 1. In an embodiment, if K=1, it is determined that the reading sequence S, corresponding to each row buffer according to the row number i of each row buffer and the storage position in the i-th row buffer where an element to be read is stored according to ceil (A/B).Sᵢ ceil is an ceiling function, A is the number of columns of the target matrix, B is the number of rows of the row buffers. If K>1, the reading sequence corresponding to each row buffer for the K-th reading operation is required by cyclically shifting the reading sequence corresponding to each row buffer for the (K−1)-th reading operation to the right by one position; for the i-th row buffer, the storage position where the element to be read is stored for the K-th reading operation is acquired by shifting ceil (A/B) positions to the left from the storage position of the element read for the (K−1)-th reading operation.

In an embodiment, as shown in FIG. 5B, the input buffer of acceleration units is a ping pong buffer (for example, the ping pong buffer includes an input bufferA and an input buffer B in FIG. 5B), to achieve pipelined buffering. In an embodiment, the acceleration unit further includes an accumulator. The transposition controller generates an accumulation control signal and outputs the accumulation control signal to the accumulator when the number of columns of the target matrix is greater than the number of rows of row buffers. The accumulator buffers subvectors to be shifted in the target row under the control of the accumulation control signal, and outputs one subvector to the shifter at a time in sequence, to enable the shifter to shift the subvectors. In an embodiment, the target row is divided into several subvectors, wherein the number of the subvectors is L and L is an integer greater than or equal to 1. In an embodiment, L=ceil (A/B). A multiplexer is coupled between an output terminal of the ping pong buffer and the accumulator. The transposition controller generates a buffer selection signal and outputs the buffer selection signal to the multiplexer, to control the multiplexer to connect the input buffer A or the input buffer B of the ping pong buffer to the input buffer of the accumulator. In an embodiment, the acceleration unit includes an input controller and an output controller. The input controller is for inputting the target matrix to the input buffer and for outputting a size of the target matrix to the transposition controller. The output controller is for informing the transposition controller when a transpose completion signal from the output buffer is received, to enable the transposition controller to send the buffer selection signal to the multiplexer, thereby achieving the switching of the input bufferA and the input buffer B of the ping pong buffer. When a reading request is received, the output controller controls the output buffer to output data corresponding to the reading request.

As described above, the data processing methods include data shift operations and read-write operations. The data shift operations are implemented by acceleration units. Read-write operations are implemented by the input buffer, row buffers, and the output buffer in the acceleration units. The control of data shift operations and read-write operations may be realized by a processor in the acceleration units. Therefore, the data processing methods are realized by the acceleration units, which apply to the computer system based on the pipelined acceleration unit structure. Moreover, data shift operations and read-write operations are basic data operating and processing operations, and the processor may realize these operations quickly and efficiently. Therefore, the data processing method has advantages, such as high efficiency and high speed.

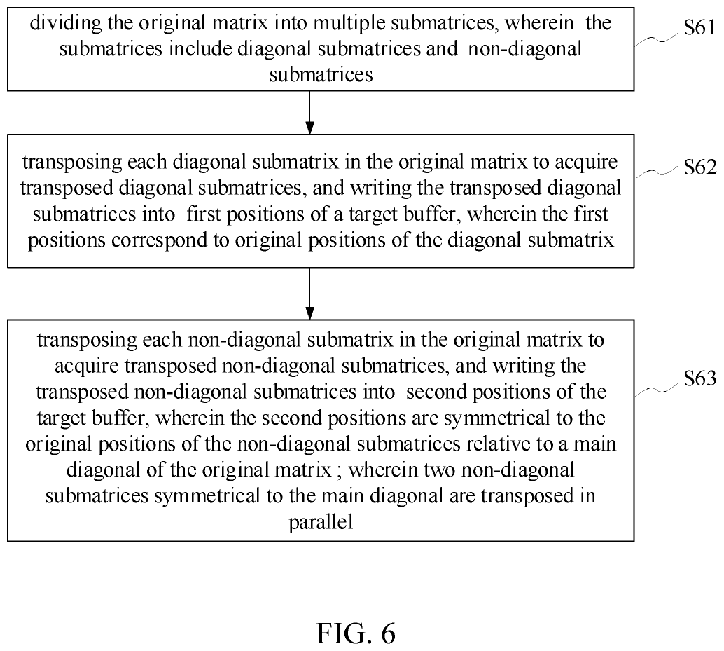

This present disclosure also provides another data processing method. The data processing method is for transposing an original matrix. In an embodiment, the original matrix is preferably a super large matrix. For example, the size of the super large matrix exceeds that of row buffers by two orders of magnitude. In an embodiment, referring to FIG. 6, the data processing method includes the following steps:

S61, dividing the original matrix into multiple submatrices, the submatrices include diagonal submatrices and non-diagonal submatrices.

S62, transposing each diagonal submatrix in the original matrix to acquire transposed diagonal submatrices, and writing the transposed diagonal submatrices into first positions of a target buffer, the first positions correspond to original positions of the diagonal submatrices. The target buffer may be the original buffer that stores the original matrix, in which case, the transposed diagonal submatrices are written into original positions of the diagonal submatrices. The target buffer may also be a buffer other than the original buffer storing the original matrix, for example, the target buffer may be the output buffer in acceleration units, in which case, the transposed diagonal submatrices are written into the first positions of the target buffer and the first positions corresponds to the original positions of the diagonal submatrices.

S63, transposing each non-diagonal submatrix in the original matrix to acquire transposed non-diagonal submatrices, and writing the transposed non-diagonal submatrices into second positions of the target buffer, the second positions are symmetrical to the original positions of the non-diagonal submatrices relative to the main diagonal of the original matrix; where two non-diagonal submatrices symmetrical to the main diagonal are transposed in parallel. The target buffer may be the original buffer that stores the original matrix, in which case the transposed non-diagonal submatrices are written into second positions of the target buffer, and the second positions are symmetrical to original positions of the non-diagonal submatrices relative to the main diagonal of the original matrix. The target buffer may also be a buffer other than the original buffer storing the original matrix, in which case, the transposed non-diagonal submatrices are written into second positions symmetrical to the original positions of the non-diagonal submatrices relative to the main diagonal of the original matrix.

In an embodiment, the data processing method shown in FIG. 2A is adopted to transpose diagonal submatrices and non-diagonal submatrices.

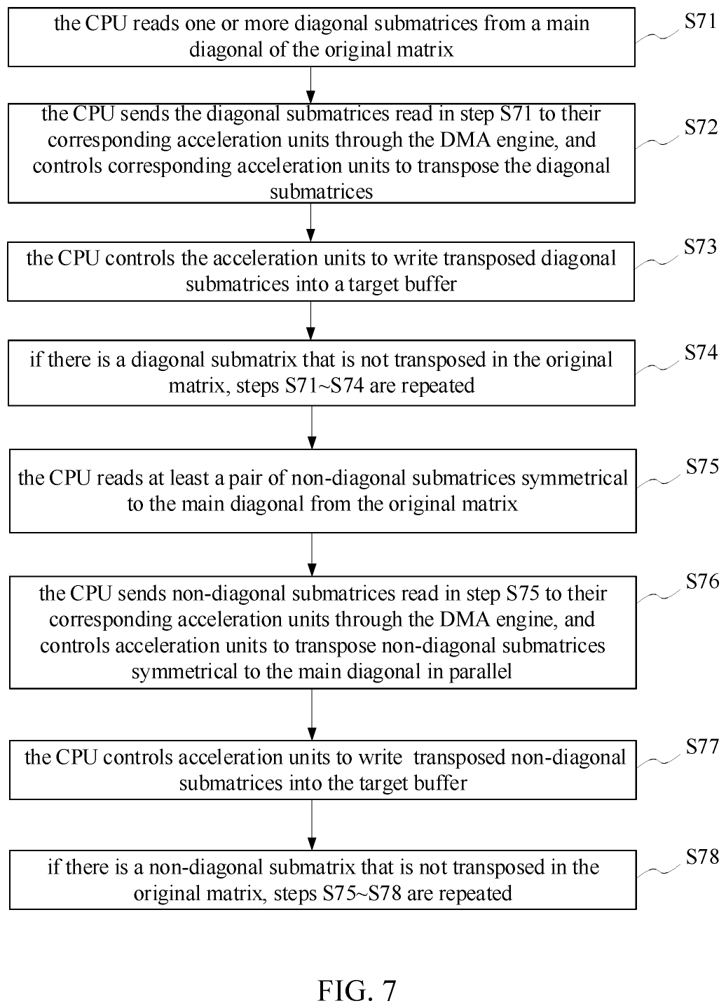

In an embodiment, referring to FIG. 7, the data processing method is implemented based on a Central Processing Unit (CPU), a Direct Memory Access DMA (DMA) engine and at least two acceleration units. The data processing method includes the following steps:

S71, the CPU reads one or more diagonal submatrices from a main diagonal of the original matrix.

S72, the CPU sends the diagonal submatrices read in step S71 to their corresponding acceleration units through the DMA engine, and controls corresponding acceleration units to transpose the diagonal submatrices.

S73, the CPU controls the acceleration units to write transposed diagonal submatrices into a target buffer.

S74, if there is a diagonal submatrix that is not transposed in the original matrix, steps S71-S74 are repeated.

S75, the CPU reads at least a pair of non-diagonal submatrices symmetrical to the main diagonal from the original matrix.

S76, the CPU sends non-diagonal submatrices read in step S75 to their corresponding acceleration units through the DMA engine, and controls acceleration units to transpose non-diagonal submatrices symmetrical to the main diagonal in parallel.

S77, the CPU controls acceleration units to write transposed non-diagonal submatrices into the target buffer.

S78, if there is a non-diagonal submatrix that is not transposed in the original matrix, steps S75-S78 are repeated.

It should be noted that, the execution sequence of steps S71-S74 and steps S75-S78 may be adjusted according to the actual requirements. In an embodiment, steps S71-S74 may be performed before steps S75-S78. In another embodiment, steps S75-S78 may be performed before steps S71-S74.

As described above, a method for dividing a super large matrix into different submatrices along the diagonal direction, transposing the submatrices and splicing the transposed submatrices respectively is provided.

The execution orders of various steps enumerated in the present disclosure are only examples of the presently disclosed techniques, and are not intended to limit aspects of the presently disclosed invention. Any omission or replacement of the steps, and extra steps consistent with the principles of the present invention are within the scope of the present disclosure.

As described above, the data processing methods described in one or more embodiments of the present application are capable of scalable matrix transposition based on different computational resources and different requirements for area and performance, and thus are practical and flexible.

In addition, the data processing methods include data shift operations and read-write operations. Data shift operations are implemented by acceleration units. Read-write operations are implemented by the input buffer, row buffers, and the output buffer in acceleration units. The data processing methods are controlled by a processor in acceleration units. Therefore, the data processing methods are realized by acceleration units, which apply to the computer systems based on the pipelined acceleration unit structure. Moreover, data shift operations and read-write operations are basic data operating and processing operations, and the processor realize these operations quickly and efficiently. Therefore, the data processing method has advantages, such as high efficiency and high speed.

The above-mentioned embodiments are just used for exemplarily describing the principle and effects of the present disclosure instead of limiting the present disclosure. Changes and variations made by those skilled in the art without departing from the spirit and scope of the present disclosure fall within the scope as specified by the appended claims.

What is claimed is:

1. A data processing method, for transposing a target matrix, comprising:
S11, reading a row of the target matrix as a target row;
S12, shifting elements in the target row along a first direction to acquire a shifted target row according to a preset offset, and writing each element in the shifted target row into a corresponding row buffer respectively;
S13, reading a next row of the target row from the target matrix as a new target row, if the next row of the target row is not the last row of the target matrix and there is an available storage space in the row buffers; wherein steps S12-S13 are performed repeatedly; and
S14, reading corresponding elements from each row buffer according to a preset rule, and writing the elements read from each row buffer into an output buffer as a row, wherein step S14 is repeated until all elements in all row buffers are written into the output buffer.

2. The data processing method according to claim 1, wherein the step of shifting elements in the target row along a first direction according to a preset offset comprises:
dividing the target row into a plurality of subvectors, and cyclically shifting elements in each subvector along the first direction according to the preset offset, wherein the number of the subvectors is L and L is an integer greater than or equal to one.

3. The data processing method according to claim 2, wherein the step of cyclically shifting elements in each subvector along the first direction comprises: cyclically shifting the elements in each subvector to the right.

4. The data processing method according to claim 2, wherein L=ceil (A/B), wherein ceil is a ceiling function, A is the number of columns of the target matrix, B is the number of rows of the row buffers.

5. The data processing method according to claim 1, wherein the preset offset is set according to the row number of the target row in the target matrix.

6. The data processing method according to claim 2, wherein the step of writing each element in the shifted target row into a corresponding row buffer respectively comprises:
sequentially writing each element of each subvector in the shifted target row into a corresponding row buffer respectively.

7. The data processing method according to claim 1, the step of reading corresponding elements from each row buffer according to a preset rule, and writing the elements read from each row buffer into an output buffer as a row comprises:
for the K-th reading operation, determining a reading sequence corresponding to each row buffer and storage positions of the elements to be read from each row buffer according to the preset rule, wherein K is an integer greater than or equal to one; and
reading corresponding elements from each row buffer according to the reading sequence and the storage positions, and writing the elements read from each row buffer into the output buffer as a row.

8. The data processing method according to claim 7, wherein the preset rule comprises:
if K=1, determining the reading sequence Sᵢ corresponding to each row buffer according to the row number i of each row buffer, and determining a storage position in the i-th row buffer where an element to be read is stored according to ceil (A/B).Sᵢ, wherein ceil is a ceiling function, A is the number of columns of the target matrix, B is the number of rows of the row buffers; and
if K>1, acquiring the reading sequence corresponding to each row buffer for the K-th reading operation by cyclically shifting the reading sequence corresponding to each row buffer for the (K−1)-th reading operation to the right by one position; for the i-th row buffer, acquiring the storage position where the element to be read is stored for the K-th reading operation by shifting ceil (A/B) positions to the left from a storage position of an element read for the (K−1)-th reading operation.

9. The data processing method according to claim 1, wherein if the number of columns of the target row is greater than the number of rows of the row buffers, the data processing method further comprises:
S15, reading a next row of the target row from the target matrix as a new target row, and writing each element in the new target row into a corresponding row buffer respectively, wherein step S15 is repeated until the new target row is the last row of the target matrix or there is no available storage space in the row buffers; and
S16, reading corresponding elements from each row buffer according to the preset rule, writing the elements read from each row buffer into a corresponding row of the output buffer, wherein step S16 is repeated until all elements in all row buffers are written into the output buffer.

10. An acceleration unit, comprising:
an input buffer, for buffering a target matrix to be transposed;
a shifter, for receiving a target row of the target matrix, and for shifting elements in the target row along a first direction under the control of a shift control signal, to acquire a shifted target row;
at least two row buffers, for buffering elements in the shifted target row and for outputting elements read correspondingly from each row buffer;
a combiner, for writing the elements read correspondingly from each row buffer into an output buffer as a row; and
a transposition controller, for generating the shift control signal according to the size of the target matrix and the number of rows of the row buffers, for controlling the input buffer to read the first row of the target matrix and outputting the first row as the target row to the shifter, for controlling the shifter to shift the target row to acquire the shifted target row, for controlling the shifter to write each element in the shifted target row into a corresponding row buffer, and for outputting the elements read correspondingly from each row buffer to the combiner.

11. The acceleration unit according to claim 10, wherein the acceleration unit further comprises
an accumulator, for buffering subvectors to be shifted in the target row under the control of an accumulation control signal, and for outputting one subvector to the shifter at a time in sequence, to enable the shifter to shift the subvectors; wherein the target row is divided into several subvectors, wherein the number of the subvectors is L and L is an integer greater than or equal to one;
wherein the transposition controller also generates the accumulation control signal and outputs the accumulation control signal to the accumulator if the number of columns of the target matrix is greater than the number of rows of the target matrix.

12. The acceleration unit according to claim 11, wherein L=ceil (A/B), wherein ceil is a ceiling function, A is the number of columns of the target matrix, and B is the number of rows of the row buffers.

13. The acceleration unit according to claim 11, wherein the shifter cyclically shifts the elements of each subvector in the target row to the right according to a preset offset.

14. The acceleration unit according to claim 13, wherein the preset offset is set according to the row number of the target row in the target matrix.

15. The acceleration unit according to claim 10, wherein the at least two row buffers determine a reading sequence corresponding to each row buffer and storage positions in each row buffer where corresponding elements to be read are stored for the K-th reading operation according to the preset rule, and read corresponding elements from each row buffer according to the reading sequence and the storage positions, and output the elements read from each row buffer to the combiner, wherein K is an integer greater than or equal to one.

16. The acceleration unit according to claim 15, wherein the preset rule comprises:
if K=1, determining the reading sequence Sᵢ corresponding to each row buffer according to the row number i of each row buffer, and determining a storage position in the i-th row buffer where an element to be read is stored according to ceil (A/B).Sᵢ, wherein ceil is a ceiling function, A is the number of columns of the target matrix, and B is the number of rows of the row buffer; and
if K>1, acquiring the reading sequence corresponding to each row buffer for the K-th reading operation by cyclically shifting the reading sequence corresponding to each row buffer for the (K−1)-th reading operation to the right by one position; for the i-th row buffer, acquiring the storage position where the element to be read is stored for the K-th reading operation by shifting ceil (A/B) positions to the left from a storage position of an element read for the (K−1)-th reading operation.

17. The acceleration unit according to claim 11, wherein the input buffer is a ping pong buffer.

18. The acceleration unit according to claim 17, further comprising:
a multiplexer, coupled between an output terminal of the ping pong buffer and the accumulator, for connecting the ping pong buffer to the input buffer of the accumulator under the control of a buffer selection signal;
wherein the transposition controller also generates the buffer selection signal and outputs the buffer selection signal to the multiplexer.

19. The acceleration unit according to claim 18, wherein the acceleration unit further comprises:
an input controller, for inputting the target matrix to the input buffer, and for outputting a size of the target matrix to the transposition controller; and
an output controller, for informing the transposition controller when a transpose completion signal from the output buffer is received, to enable the transposition controller to send the buffer selection signal to the multiplexer, thereby switching the ping pong buffer.

20. A data processing method, for transposing an original matrix, comprising:
dividing the original matrix into a plurality of submatrices, wherein the submatrices comprise diagonal submatrices and non-diagonal submatrices;
transposing each diagonal submatrix in the original matrix to acquire transposed diagonal submatrices, and writing the transposed diagonal submatrices into first positions of a target buffer, wherein the first positions correspond to original positions of the diagonal submatrices;
transposing each non-diagonal submatrix in the original matrix to acquire transposed non-diagonal submatrices, and writing the transposed non-diagonal submatrices into second positions of the target buffer, wherein the second positions are symmetrical to the original positions of the non-diagonal submatrices relative to a main diagonal of the original matrix; wherein two non-diagonal submatrices symmetrical to the main diagonal are transposed in parallel;
wherein the step of transposing each submatrix in the original matrix comprises:
S11, reading a row of the target matrix as a target row;
S12, shifting elements in the target row along a first direction to acquire a shifted target row according to a preset offset, and writing each element in the shifted target row into a corresponding row buffer respectively;
S13, reading a next row of the target row from the target matrix as a new target row, if the next row of the target row is not the last row of the target matrix and there is an available storage space in the row buffers, wherein steps S12-S13 are performed repeatedly; and
S14, reading corresponding elements from each row buffer according to a preset rule, and writing the elements read from each row buffer into an output buffer as a row, wherein step S14 is repeated until all elements in all row buffers are written into the output buffer.
